(19) United States
(12) Patent Application Publication
(10) Pub. No.: US 2005/0096441 A1
(43) Pub. Date: May 5, 2005

(54) Crosslinkable vinylpolymer and process for the preparation thereof

(76) Inventor: Shuso Iyoshi, Hiroshima (JP)

Correspondence Address: MORGAN & FINNEGAN, L.L.P., 3 World Finnancial Center, New York, NY, 10281-2101, US

(21) Appl. No.: 11/004,128

(22) Filed: Dec. 3, 2004

Related U.S. Application Data
(62) Division of application No. 10/410,391, filed on Apr. 9, 2003.

(30) Foreign Application Priority Data
Apr. 9, 2002 (JP) 2002-106432

(51) Int. Cl. C08F 4/28

(52) U.S. Cl. 526/227; 526/319

(57) ABSTRACT

The reaction of a vinyl monomer (A), an unsaturated fatty acid hydroxyalkyl ester-modified polycaprolactone (B) and a radical polymerization initiator (I) in a continuously mixing reactor can provide a crosslinkable vinyl polymer (C) having a number average molecular weight of about 500 to about 10,000. A cured product thereof has a high elasticity and a high strength, and finds many applications, for example, paints, coating materials, adhesives and pressure-sensitive adhesives.

### BACKGROUND OF THE INVENTION

1. Field of the Invention

The present invention relates to a crosslinkable vinyl polymer having a narrow molecular weight distribution, a low viscosity and a high solids content and to a continuous bulk polymerization process. The crosslinkable vinyl polymer of the present invention can provide a resin that has a high strength and a high elasticity by crosslinking, so that it is particularly suited for use in paints, coating materials, adhesives, pressure-sensitive adhesives and the like.

2. Description of the Related Art

Conventional solvent-based acrylic polymer solutions for industrial use have many problems. Solvents become a cause of environmental pollution and are dangerous in handling them since they have inflammability and toxicity. In addition, final products may sometimes become discolored because of solvents, thus causing the problem of a remarkable decrease in the quality of final products.

As substitutes for such the solvent-based acrylic polymer, acrylic polymer solutions of the solvent-free type or those having high solids contents have received attention. Herein, a polymer solution having a high solids content means a polymer solution having a content of solids (nonvolatile content) of at least about 70%. Polymer solutions having high solids contents have remarkable advantages as compared with conventional polymer solutions of the solvent-diluted type. That is, they have high energy efficiencies and allow achievement of labor savings since they cause less environmental pollution and require less energy for drying the solvent. Further, the dangerousness of fire and toxic symptoms due to the solvent can be decreased.

Acrylic polymers have a wide range of characteristics provided by various combinations of raw material monomers and hence they are used in paints, coating materials, adhesives, pressure-sensitive adhesives and other applications. In particular, formation of a copolymer from a functional monomer, i.e., a monomer having a functional group, and a non-functional monomer and utilization of the functional group in the copolymer for crosslinking can provide a final resin having an excellent strength and excellent modulus. However, generally, the functional group of the functional monomer is located at a position close to the main chain, resulting in a high intercrosslinking density, thus raising the problem that the obtained cured product tends to become hard and brittle.

The most important issue that is concerned about when solvent-free acrylic polymers or acrylic polymer solutions having high solids contents are used as coating materials or adhesives is viscosity. If the viscosity of the polymer or polymer solution is high, not only its handling and operation are difficult but also its coatability is poor so that no satisfactory finishing of products can be obtained. On the other hand, to decrease the viscosity of the polymer or polymer solution, an acrylic polymer having an unnecessarily lower molecular weight must be used or a large amount of a solvent must be used. A polymer having a low molecular weight has an insufficient strength of the coating or an insufficient adhesive strength after curing and where a large amount of a solvent is used, there arise various problems such as the problem of working environment and the problem of a decrease in efficiency due to drying of the solvent.

It has been known that a preferable range of the viscosity of acrylic polymers is about 0.1 to about 5 Pa.s. Also, it has been known that to provide a resin having not so much a decreased molecular weight, low viscosity and satisfactory coating performance, it is necessary to prepare a resin having an extremely narrow molecular weight distribution. In Takahashi: “Recent Advances in High Solids Coatings”, Polm. Plast. Technol. Eng., 15(1), No. 1, p.10 (1980), it has been revealed that the existence of a high molecular weight component of a polymer has an influence on the viscosity characteristic of the resin.

The molecular weight distribution and distribution index of a polymer indicate whether or not there exists a high molecular weight component in the polymer.

Molecular weight distribution (which is a ratio of a weight average molecular weight to a number average molecular weight and expressed as Mw/Mn) is extremely important in this art. Polymers having the same average molecular weight but having different molecular weight distributions have different solution viscosities. Polymers having broader molecular weight distributions always have higher solution viscosities. This is because polymers have relatively large contents of a high molecular weight component, making a remarkably high degree of contribution to the viscosity. If a polymer has a high solution viscosity, it has a poor coatability when paint is prepared therefrom.

There is another measure of a molecular chain length known as sedimentation average molecular weight Mz. Relatively, Mn<Mw<Mz is satisfied. Where the molecular chain length is quite uniform, Mn=Mw=Mz is satisfied. However, generally, it is impossible to obtain such a polymer.

Mz may be used as a measure of the proportion of a high molecular weight component in the molecular weight distribution. Distribution index (which is a ratio of Z average molecular weight to number average molecular weight and expressed as Mz/Mn) is a major measure of the molecular weight distribution of any given polymer and indicates whether the high molecular weight component is much or little. A polymer having a high distribution index has a high solution viscosity and exhibits a poor coatability.

It has been demanded that a suitable process for preparing a polymer that is suited for use in high solids content paints have a sufficient versatility to such an extent that the molecular weight, molecular weight distribution and distribution index of an objective product can be increased or decreased to the market needs. Further, a polymer having an extremely low molecular weight containing a suitable amount of a dimer, trimer or the like of a monomer has a skewed number average molecular weight (Mn), thereby decreasing the quality of the polymer considerably.

The advantages of acrylic resins include a relatively lower price, a transparency and colorlessness, an excellent outdoor durability, a chemical resistance, an excellent heat stability and so forth. To make the most of the excellent advantages, it has been attempted to produce acrylic copolymers having high solids contents having an Mn in the range of about 500 to about 10,000. However, no process for the production of non-styrene-based acrylic polymer products having a narrow molecular weight distribution, a satisfactory color, a practically satisfactory low viscosity, a high solids content and a low molecular weight in high yields has been completely successful.

Conventional free radical-initiated polymerization processes for the production of low molecular weight acrylic copolymers have various disadvantages.

U.S. Pat. No. 4,276,432 discloses a production process for acrylic- and/or styrene-based polymers having an Mn (according to a vapor phase osmotic pressure method) of 750 to 5,000. In this process, a reaction solvent must be added in an amount of 40 to 70% by weight with respect to the weight of the monomer and the reaction time is as long as 1 to 10 hours. Due to a large amount of solvent used in this process, a stripping operation for excessive solvent is required and the time in which the reaction mass is supplied to the stripping step is long. These factors are disadvantageous in respect of manpower, cost and energy. Further, this process uses an excess amount of a solvent that is inflammable, has toxicity and contaminates the polymer, thereby raising a serious problem.

U.S. Pat. No. 4,117,235 discloses production of an acrylate polymer having a number average molecular weight of about 5,000 or less by thermal polymerization of an acrylic monomer in a sealed glass tube at 230 to 280° C. in the presence or absence of chain transfer agents or solvents. The reaction time is 16 to 18 hours, which is too long. This polymerization process is a batch process, in which a large amount of monomer is added and the reaction is carried out for a long time.

An object of the present invention is to provide a crosslinkable vinyl polymer that has a low viscosity and is of the solvent-free or high solids content type (hereinafter, solids content means nonvolatile content inclusive of a polymer in a liquid state), a cured product of which polymer has a high elasticity and a high strength and which polymer finds a wide application such as paints, coating materials, adhesives and pressure-sensitive adhesives.

The inventors of the present invention have found that bulk polymerization of a vinyl monomer and an unsaturated fatty acid hydroxyalkyl ester-modified polycaprolactone represented by the formula (1) described hereinbelow in a continuously mixing reactor can provide a crosslinkable vinyl polymer that can form a cured product having an excellent impact strength and such problems as described above can be solved. Thus, the present invention has been accomplished.

### SUMMARY OF THE INVENTION

According to a first aspect of the present invention, there is provided a continuous bulk polymerization process for production of a crosslinkable vinyl polymer (C), including reacting a vinyl monomer (A), an unsaturated fatty acid hydroxyalkyl ester-modified polycaprolactone (B) represented by general formula (1) 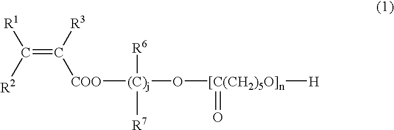
(where R¹, R² and R³, which are same or different from each other, independently represent a hydrogen atom or an alkyl group having 1 to 7 carbon atoms, or an alkoxy group having 1 to 7 carbon atoms, and R⁶ and R⁷ independently represent a hydrogen atom or an alkyl group having 1 to 10 carbon atoms; j is an integer of 2 to 7, provided that (R⁶)s and (R⁷)s attached to j pieces of carbon atoms are same or different from each other; and n is an integer of 1 to 10), and a radical polymerization initiator (I) in a continuously mixing reactor to produce the crosslinkable vinyl polymer having a number average molecular weight of about 500 to about 10,000.

According to a second aspect of the present invention, there is provided the continuous bulk polymerization process as described in the first aspect of the invention, in which the vinyl monomer (A) includes an acrylic monomer.

According to a third aspect of the present invention, there is provided the continuous bulk polymerization process as described in the first or second aspect of the invention, in which the unsaturated fatty acid hydroxyalkyl ester-modified polycaprolactone (B) includes an adduct of about 1 mol of an unsaturated fatty acid hydroxyalkyl ester with about 1 to about 10 mol of ε-caprolactone.

According to a fourth aspect of the present invention, there is provided the continuous bulk polymerization process as described in the third aspect of the invention, in which the unsaturated fatty acid hydroxyalkyl ester includes hydroxyethyl (meth)acrylate.

According to a fifth aspect of the present invention, there is provided the continuous bulk polymerization process as described in any one of the first to fourth aspects of the invention, in which the crosslinkable vinyl polymer includes about 0.1 to about 70% by weight of a unit derived from the unsaturated fatty acid hydroxyalkyl ester-modified polycaprolactone (B) based on 100% by weight of total units derived from the vinyl monomer (A) and the unsaturated fatty acid hydroxyalkyl ester-modified polycaprolactone (B).

According to a sixth aspect of the present invention, there is provided the continuous bulk polymerization process as described in any one of the first to fifth aspects of the invention, in which the radical polymerization initiator (I) includes at least one member selected from the group consisting of a peroxide and a hydroperoxide.

According to a seventh aspect of the present invention, there is provided the continuous bulk polymerization process as described in any one of the first to sixth aspects of the invention, in which the radical polymerization initiator (I) is added in a ratio of about 0.0005 to about 0.06 mol per mol of total of the vinyl monomer (A) and the unsaturated fatty acid hydroxyalkyl ester-modified polycaprolactone (B).

According to an eighth aspect of the present invention, there is provided the continuous bulk polymerization process as described in any one of the first to seventh aspects of the invention, in which a yield of the polymerization reaction is about 90% by weight or more.

According to a ninth aspect of the present invention, there is provided the continuous bulk polymerization process as described in any one of the first to eighth aspects of the invention, in which the polymerization reaction is carried out by adding a solvent (S) for a reaction in a ratio of about 25% by weight or less based on 100% by weight of total of the vinyl monomer (A) and the unsaturated fatty acid hydroxyalkyl ester-modified polycaprolactone (B).

According to a tenth aspect of the present invention, there is provided the continuous bulk polymerization process as described in the ninth aspect of the invention, in which the solvent (S) for a reaction is at least one member selected from the group consisting of aromatic or aralkyl alcohols; aliphatic glycols; (poly)alkylene glycol dialkyl ethers; aliphatic or aromatic ethers; alicyclic or aromatic esters; and alicyclic or aromatic hydrocarbons with a boiling point of about 100 to about 270° C.

According to an eleventh aspect of the present invention, there is provided the continuous bulk polymerization process as described in any one of the first to ninth aspects of the invention, further including, after performing the polymerization reaction, removing at least one member selected from unreacted monomers, reaction by-products and the solvent (S) for a reaction.

According to a twelfth aspect of the present invention, there is provided the continuous bulk polymerization process as described in any one of the first to eleventh aspects of the invention, in which the reaction is carried out at a temperature of about 180 to about 270° and a retention time of about 1 to about 50 minutes.

According to a thirteenth aspect of the present invention, there is provided a crosslinkable vinyl polymer including a polymerization reaction product of a vinyl monomer (A) with an unsaturated fatty acid hydroxyalkyl ester-modified polycaprolactone (B) represented by the general formula as described in the first aspect of the invention, the polymer having a number average molecular weight of about 500 to about 10,000, a molecular weight distribution (i.e., weight average molecular weight/number average molecular weight) of about 1 to about 3, and a distribution index (Z average molecular weight/number average molecular weight) of about 3 to about 5.

According to a fourteenth aspect of the present invention, there is provided the crosslinkable vinyl polymer as described in the thirteenth aspect of the invention, in which the polymerization product has a non-volatile content of about 75% by weight or more.

### DETAILED DESCRIPTION OF THE INVENTION

The present invention relates to a crosslinkable vinyl polymer (C) that is prepared by a polymerization reaction between a vinyl monomer (A) (hereinafter, also referred to as “component (A)”) and an unsaturated fatty acid hydroxyalkyl ester-modified polycaprolactone (B) (hereinafter, also referred to as “component (B)”) represented by the formula (1) above and that has a number average molecular weight of about 500 to about 10,000, a molecular weight distribution (weight average molecular weight/number average molecular weight) of about 1 to about 3, and a distribution index (Z average molecular weight/number average molecular weight) of about 3 to about 5, and to a continuous bulk polymerization process for the polymer (C) by use of a continuous mixing reactor in a short time and in addition, in a high yield.

The component (B) has a reactive hydroxyl group at a terminal thereof, so that the paints including the resulting polymer (C) improved the physical and chemical characteristics of the final products, such as strength, modulus, solvent resistance, and oil resistance when they are crosslinked after coated.

In particular, since crosslinkable side chains contain lactone chains, which are soft segments, the component (B) has an advantage that it provides a cured product with resilience and thereby obviates the brittleness due to crosslinking. Thus, proper selection of the amount of the cyclic lactone to be added enables one to choose as desired the intercrosslinking density of the finally obtained polymer, so that the elasticity, strength, and hardness of the objective polymer can be designed in any desired balance.

<Component (A)>

The vinyl monomer (A) used in the present invention includes at least an acrylic monomer.

The acrylic monomer used in the present invention includes (meth)acrylic acid, (meth)acrylates, or derivatives and mixtures thereof. Suitable examples of the acrylic monomer include methyl (meth)acrylate, ethyl (meth)acrylate, n-propyl (meth)acrylate, isopropyl (meth)acrylate, isobutyl (meth)acrylate, n-butyl (meth)acrylate, n-amyl (meth)acrylate, isoamyl (meth)acrylate, n-decyl (meth) acrylate, n-hexyl (meth)acrylate, 2-hydroxyethyl (meth)acrylate, 2-hydroxypropyl (meth)acrylate, N,N-dimethylaminoethyl (meth)acrylate, N,N-diethylaminoethyl (meth)acrylate, t-butylaminoethyl (meth)acrylate, 2-sulfoethyl (meth)acrylate, trifluoroethyl (meth)acrylate, benzyl (meth)acrylate, 2-n-butoxyethyl (meth)acrylate, 2-chloroethyl (meth)acrylate, sec-butyl (meth)acrylate, tert-butyl (meth)acrylate, 2-ethylbutyl (meth)acrylate, cinnamyl (meth)acrylate, cyclohexyl (meth)acrylate, cyclopentyl (meth)acrylate, 2-ethoxyethyl (meth)acrylate, furfuryl (meth)acrylate, hexafluoroisopropyl (meth)acrylate, 3-methoxybutyl (meth)acrylate, 2-methoxybutyl (meth)acrylate, 2-nitro-2-methylpropyl (meth)acrylate, n-octyl (meth)acrylate, 2-ethylhexyl (meth)acrylate, 2-phenoxyethyl (meth)acrylate, 2-phenylethyl (meth)acrylate, phenyl (meth)acrylate, propargyl (meth)acrylate, tetrahydrofurfuryl (meth)acrylate, and tetrahydropyranyl (meth)acrylate. Among these preferred are methyl (meth)acrylate, ethyl (meth)acrylate, n-propyl (meth)acrylate, isopropyl (meth)acrylate, n-butyl (meth)acrylate, and n-decyl (meth)acrylate.

In the component (A), those monomers other than the acrylic monomers include styrene, α-methylstyrene, vinyl acetate, butadiene, isoprene, etc.

The content of the acrylic monomer in the component (A) is 50% by weight or more, preferably 60% by weight or more, and more preferably 70% by weight or more. If the content of the acrylic monomer is less than 50% by weight, the problem arises that the inherent characteristics, i.e., high strength and high elasticity, in an acrylic resin cannot be obtained.

<Component (B)>

The unsaturated fatty acid hydroxyalkyl ester-modified polycaprolactone (B) used in the present invention has the structure represented by the formula (1) as described above and can be obtained by ring opening addition of caprolactone to a hydroxyl group of an unsaturated fatty acid hydroxyalkyl ester, such as hydroxyalkyl (meth)acrylate, used as an initiator as disclosed in, for example, JP 63-66307 B. More generally, the ring opening addition of a cyclic lactone represented by the general formula (2) below similarly provides an unsaturated fatty acid hydroxyalkyl ester-modified polylactone.

The hydroxyalkyl means an alkyl group having 2 to 10 carbon atoms with a hydroxyl group. The alkyl chain thereof may be linear or have branches. Further, the position of substitution of the hydroxyl group may be located terminally or internally, and may be an α-position of an ester group, with the terminus being preferred. 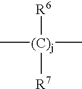
(j is an integer of 2 to 7; and R⁶ and R⁷ represent independently a hydrogen atom or an alkyl group having 1 to 10 carbon atoms, provided that R⁶s and R⁷s attached to j pieces of carbon atoms may be the same or different from each other. 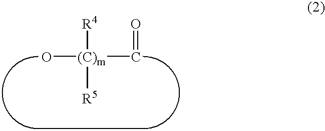
(R⁴ and R⁵ represent independently a hydrogen atom or an alkyl group having 1 to 7 carbon atoms; and m is an integer of 1 to 10.)

Specific examples of the unsaturated fatty acid group in the structure represented by the formula (1) include a (meth)acryloyl group, an (iso)crotonoyl group and the like.

Specific examples of the hydroxyalkyl group in the structure represented by the formula (1) include a 2-hydroxyethyl group, a 2-hydroxypropyl group, a 3-hydroxypropyl group, a 4-hydroxybutyl group, a 3-chloro-2-hydroxypropyl group, a 2-hydroxybutyl group, a 6-hydroxyhexyl group, a 5,6-dihydroxyhexyl group and the like.

Specific examples of the hydroxyalkyl (meth) acrylate include hydroxyethyl (meth)acrylate, hydroxypropyl (meth)acrylate, hydroxybutyl (meth)acrylate, and the like. From the viewpoint of easy availability, hydroxyethyl (meth)acrylate is preferable.

The cyclic lactone includes ε-caprolactone, methylated ε-caprolactone, β-propiolactone, γ-butyrolactone, δ-valerolactone, ζ-enantholactone, and mixtures thereof. In particular, ε-caprolactone is preferable.

In the crosslinkable vinyl polymer produced by the process of the present invention, the content of a unit derived from the component (B) (hereinafter, also referred to as component (B) unit) is 0.1 to 50% by weight, preferably 2 to 30% by weight, based on 100% by weight of the total of the units derived from the component (A) and the component (B). If the content of the component (B) unit is below 0.1% by weight, no effect of introduction of a soft segment can be obtained and the final product has a low crosslinking density. On the other hand, if the content of the component (B) unit is above 70% by weight, the final product has too high crosslink density to become brittle.

<Radical Polymerization Initiator (I)>

The radical polymerization initiator (I) used in the present invention may be any compound so far as it generates a free radical by a thermal decomposition reaction. Preferably, the radical polymerization initiator (I) is a compound that has a half life (potlife) of radicals in a thermal decomposition reaction of about 1 hour or more at 90° C., more preferably 10 hours or more at 100° C. However, compounds that have half lives of about 10 hours at 100° C. or less may be used.

Specific examples of such radical polymerization initiator include aliphatic azo compounds such as 1-t-amylazo-1-cyanocyclohexane, azobisisobutyronitrile, and 1-t-butylazo-cyanocyclohexane; peroxides such as t-butyl peroctanoate, t-butylperbenzoate, dicumyl peroxide, and di-t-butyl peroxide; and hydroperoxides such as t-butyl hydroperoxide and cumyl hydroperoxide, and so forth.

The radical polymerization initiator (I) is preferably fed along with the comonomers. For this purpose, the initiator is mixed with a monomer prior to feeding or fed to a reaction system with an another supply line for raw materials. The amount of the initiator (I) is important in the process of the present invention.

It has previously been conceived that the conventional polymerization process for the production of a polymer having a narrow molecular weight distribution, a low viscosity and satisfactory color requires coexistence of a styrene-type monomer in view of its total reaction rate. In contrast, in the continuous bulk polymerization process according to the present invention, low molecular weight polymers can be produced at temperatures of 180 to 270° C. without any styrene-based monomers and furthermore only with a few percents of a free-radical initiator.

Generally, the molar ratio of the initiator (I) to the total of the component (A) and the component (B) must be about 0.04:1 or less. Although under certain circumstances, a slightly higher ratio may be used as necessary, the molar ratio is usually up to about 0.06:1. Another means for decreasing the molecular weight of the product and improving its molecular weight distribution may be used.

Use of an excessive initiator is uneconomical and it neither particularly improves the properties of the produced polymer nor gives any influence on the reaction conditions. However, a maximal conversion and weight distribution are achieved usually at a molar ratio of the initiator to the total of the comonomers of about 0.005:1 to 0.04:1. Industrially, it is particularly preferable to use a molar ratio of the initiator to the total of the comonomers of about 0.005:1 to about 0.015:1.

Since the only one source for initiating the reaction is considered to be the initiator (I), it is quite surprising that such a relatively small amount of the initiator can produce a product having a narrow molecular weight distribution and a low molecular weight. Further, the yield of the process of the present invention is close to a usual quantitative yield, i.e., a theoretical yield (100%), and is 90% or more as will be described hereinbelow.

At polymerization temperatures outside the range of 180 to 270° C., various problems arise. If the polymerization temperature is lower than the above-mentioned range, the molecular weight of the product increases. The products formed at low temperatures have high viscosities and thus are difficult to handle. If the polymerization temperature is above the above-mentioned range, a dimer and trimer are generated excessively. “Ceiling temperature” as used herein means the temperature at which the polymerization rate is equal to the depolymerization rate. In the vicinity of the ceiling temperature, the polymerization rate is decreased due to a competition between polymerization and depolymerization and the resultant polymer has a decreased molecular weight and a decreased conversion and an increased heterogeneity.

This phenomenon partly explains the existence of an excess amount of impurities and chromophores (discolored substances formed at temperatures of about 270° C. or more). Further, at high reaction temperatures, severer requirements are posed on valves, seals and joints of a conventional polymerizing apparatus. As described above, high temperatures increase the tendencies of the occurrence of failure, leakage and overheating.

To obtain desirable results of the present invention, it is desirable to add a small amount of a chain transfer agent, in order to optionally obtain a specified property or particularly to prepare a product having a low molecular weight. The chain transfer agent can be used in an amount of, for example, at most around 2% by mole to the total mole of the comonomers. The chain transfer agent includes, for example, bromotrichloromethane, isooctyl β-mercaptopropionate and the like.

<Solvent (S) for a Reaction>

In the continuous bulk polymerization process of the present invention, a solvent (S) for a reaction can be used, as necessary, in an amount of at most about 25% by weight, preferably at most about 15% by weight,, to 100% by weight of the total of the component (A) and the component (B). When a solvent is used, the solvent may be fed along with the monomer which is one of raw materials to be fed or may be separately fed to the reaction system. Selection of a specific solvent and its amount to be added depends on the selected monomer and target application of the resulting polymer, and also the solvent serves to aid the control of reaction parameters. Generally, it is preferable that a minimum amount of the solvent be used in order to alleviate the conditions of separation and recovery and minimize formation of contaminated components. The phenomenon that occurs due to the chain transfer caused by the use of the solvent is the formation of an excessive dimer, trimer and by-production of chromophore.

The solvent (S) for a reaction used in the present invention includes alicyclic or aromatic alcohols; aliphatic or alicyclic glycols; (poly) alkylene glycol dialkyl ethers; alicyclic or aromatic ethers; alicyclic or aromatic esters; alicyclic or aromatic hydrocarbons; and mixtures thereof, having a boiling point of about 100 to about 270° C.

Generally, the use of solvents helps to lower the reaction temperature and the solution viscosity of the molten polymer product and to prevent uncontrolled reactions by its heat releasing effect.

To produce the polymer (C) of the present invention, solvents generally used for a reaction may also be used in the process of the present invention. Solvents having the higher boiling points tends to have the lower vapor pressures at elevated temperatures and thus are preferable. Usually, solvents having a boiling point of 100° C. or more, in particular, 150° C. or more, are more preferable. Examples of solvents having such the high boiling point include aromatic alcohols such as benzyl alcohol; and ethers, esters, mixed ethers, and mixed esters between alcohol and glycol, such as diethylene glycol, cellosolve (ethylene glycol monoethyl ether), butyl cellosolve, cellosolve acetate, carbitol (diethylene glycol monoethyl ether), and (poly)alkylene glycol dialkyl ester.

Further, if the reaction can be suppressed at a minimal, certain glycols may also be used as reaction solvents and examples of such glycols include ethylene glycol, propylene glycol, butylene glycol and various kinds of polyether polyols. For example, aliphatic alcohols such as hexanol and decanol may also be used. Further, various kinds of hydrocarbon fractions may also be used. Most preferred are Solvesso 150 or Solvesso 100 (Solvesso being registered trademark of Humble Oil and Refining Company). Aromatic solvents, for example, toluene, xylene, cumene, and ethylbenzene may also be used.

Preferred solvents are cellosolve acetate and Isopar (registered trademark of Exxon Chemical for an isoparaffin hydrocarbon). Particularly useful isoparaffin hydrocarbons have boiling points in the range of about 130 to about 190° C.

<Crosslinkable Vinyl Polymer (C)>

According to the process of the present invention, the high solids content crosslinkable vinyl polymer (C) having a non-volatile (NV) content of about 75 to about 99% can be produced in a conversion (from monomer to polymer) of at least about 90% of the theoretical yield, i.e., at a yield of about 90% or more.

Further, the obtained crosslinkable vinyl polymer (C) has an Mn of about 500 to about 10,000, preferably about 1,000 to about 6,000, particularly preferably about 1,000 to about 3,500. Unless otherwise noted, the molecular weights are the ones that are determined by gel permeation chromatography (GPC).

Such resins as described above, whether they are used with or without paint solvents, must be about 0.1 to about 5 Pa.s in viscosity depending on Tg and its end application. For a thermosetting usage, preferable viscosity is about 0.5 to about 1 Pa.s.

The molecular weight distribution of the crosslinkable vinyl polymer (C) is about 3 or less, preferably about 2.5 or less, and more preferably about 1.5 to about 2.2.

The distribution index of the crosslinkable vinyl polymer (C) is 6.0 or less, preferably 5.0 or less for the best results.

The glass transition temperature (Tg) of the crosslinkable vinyl polymer (C) produced by the present invention depends on monomers to be used, compositions and molecular weight of the polymer.

Tgs of the crosslinkable vinyl polymer (C) determine the form of the obtained resin, liquid or solid.

Most polymer products can be selectively formed as a solid or liquid depending on the target final application.

In the continuous bulk polymerization process of the present invention, a conventional continuous stirring reactor may be used as a continuously mixing reactor.

<Production of Crosslinkable Vinyl Polymer (C)>

The component (A), component (B), a small amount of initiator (I), and solvent (S) as an optional component are continuously supplied into a continuous mixing reactor. The continuous mixing reactor is maintained at a reaction temperature previously set and the reaction mass (composed of crosslinkable vinyl polymer (C), unreacted raw material component (A) and component (B), by-products such as a dimer and trimer, and solvent (S) as an optional component) is pumped out from the reaction region at the same flow rate at which the raw material monomers are supplied so that the reaction mass can maintain a constant volume level in the system.

The molten resin mixture in the reaction region is allowed to react acceleratively and is maintained at a high reaction temperature that facilitates production and is sufficient for making a uniform, concentrated polymer products. Generally, for this or other purpose, the reaction temperature is maintained preferably at about 180 to about 270° C. At temperatures less than about 180° C., the polymer as a product (hereinafter, referred to simply as polymer) tends to have a molecular weight higher than and a molecular weight distribution broader than that generally accepted as a high solids content paint unless an excess solvent is added. The reaction conversion is decreased and a high molecular weight content is increased. The obtained polymer tends to have a moderately increased viscosity for efficient processing and it is not easy to obtain a polymer having a high solids content.

At reaction temperatures of about 180 to about 215° C., in the process of the present invention, it is in most cases effective to increase the conversion and uniformity of polymer, decrease chromophores, and decrease the viscosity by use of solvents. If necessary, the amount of the initiator used may be increased to make better the reaction parameters and improve the properties of the polymer.

When the reaction temperature approaches or exceeds about 280° C., the quality of the polymer is deteriorated. For example, higher reaction temperatures tend to give discolored polymers and cause yellowing presumably formed due to formation of undesirable by-products, for example, oxidation by-products. Further, the polymer undergoes moderate ceiling temperature effects such as depolymerization, reversible reactions and other side reactions to generate dimers, trimers and other low molecular weight oligomer-based contaminants. Such the by-products contaminate the products and contribute to color shift or render the quality of the finish coating of a coating composition made therefrom lower than the standard level. Further, the reactor will be rapidly deteriorated under such high temperatures and leakage of the reaction mass from the valves, joints and sealed portions may occur. Generally, it is further preferable that a reaction temperature of about 215 to about 260° C. is used since the best results can be obtained.

Generally, the retention time in the reaction region is controlled by the flow rate of a component that passes the reaction system. The retention time is inversely proportional to the flow rate. At any given temperature, generally the molecular weight of a polymer will increase, as the retention time becomes longer.

The lower limit of the retention time in many cases is controlled by removal of polymerization heat. Further, when the retention time becomes longer, the reaction conditions are difficult to attain in a stationary state. The retention time in the reaction region reaches even 1 hour when the reaction temperature is low, and in such a case, usually the retention time is forced to be shortened to avoid discoloration reaction and other side reactions.

Therefore, in consideration of these factors, it is preferable that the retention time is set minimal and the reaction is sufficiently completed.

The retention time is about 1 to about 50 minutes, preferably about 1 to about 30 minutes, and more preferably about 1 to about 20 minutes. Generally, the longer the retention time, the more the yield of the polymer is increased. However, generally the rate of increase in the yield of polymer is very much decreased after about 30 minutes from the start of the reaction. To be more important, after about 30 minutes from the start of the reaction, depolymerization tends to occur, resulting in the formation of undesirable chromophores and by-products.

Selection of flow rate depends on the reaction temperature, components, and the molecular weight, molecular weight distribution, and distribution index of the target product as well as the specified apparatus used. In preparing target resins having predetermined Mn, Mw and Mz with minimized residual monomers, mutual control of the reaction temperature and retention time in accordance with the principle of the present invention can provide the best results.

The reaction pressure in a sealed system is a function between residual vapor pressures of unreacted monomers and substances (for example, water) that may be present in the supplied raw materials or other volatile components that exist in the reaction mass. In a stationary state, the process of the present invention is implemented under pressure. However, the reaction pressure is considered to give no influence on the yield. The upper limit of the reaction pressure is a function of the volume of the apparatus while the lower limit is a function between the raw material supply rate and the monomer composition. The higher is the temperature, the higher the resultant gas pressure becomes and the special apparatus and procedures are required for safe operation.

The process of the present invention can attain a yield of about 90% or more of the theoretical yield without circulating monomers. In the present invention, proper selection of reaction parameters and monomers usually attains a yield of 90 to 99% of the theoretical yield in a retention time of 1 to 20 minutes, with a non-volatile content of 90 to 99%.

In the present invention, as a continuously mixing reactor in which the components (A) and (B) are reacted under polymerization conditions and flow rate that are properly balanced therebetween to provide the crosslinkable vinyl polymer (C) having a narrow molecular weight distribution, a variable-loading type reactor having an agitator, an extruder or a reverse-flow mixing reactor may be used if it is properly modified.

For a preferable continuously mixing tank type reactor, any type that allows variable loading operation whose reaction region has a volume of a minimum of 10% to a maximum of 100% of the available volume for vinyl polymer production is cited.

The continuously stirring tank type reactor, whether the make is horizontal or vertical, must be controlled at precise internal temperatures, fitted with a cooling jacket, an internal cooling coil, or by any desired means that controls the extraction of evaporated monomer, condensation of monomer, and returning the condensed monomer to the reaction region. The reaction region may be constructed by a plurality of continuously stirring tank type reactors that are serially operated if necessary. For similar purposes, two or more relatively small reactors may be provided in parallel and used.

A preferred type of continuously stirring reactor is a tank type reactor equipped with a cooling coil that is sufficient for removing the polymerization heat of the continuously supplied monomer composition in order to maintain the preselected reaction temperature. More preferably, such a continuously stirring tank type reactor is provided with at least one, usually more than one vane-type stirrer that is driven by an outer power source such as a motor. At least one such the stirrer is arranged so that it can stir the liquid charged in the reactor at a minimal loading, that is, when operated with a load of 10% of the volume thereof at the smallest. If necessary, such a continuously stirring tank type reactor may be provided with an additional means for increasing the efficiency of operation and safety, for example, a series of additional internal cooling coil for effectively preventing acceleration of polymerization when usual retention time is prolonged for some reasons or an outer jacket for additional cooling or heating of the content in the reactor.

The continuous bulk polymerization process of the present invention can be realized by properly selecting the polymerization reaction conditions depending on the form of the polymer to be produced and the flexibility of selection and range of production speed. The operation proceeds as follows. That is, the above-mentioned components (A) and (B) and the polymerization initiator (I) are supplied separately or after two or all of them are mixed to a reactor and the raw material mixture is heated to about 180 to about 270° C. to initiate polymerization. The monomers are supplied to the reactor as a mixture or separately from the respective raw material tanks.

First, the monomers for the reaction are filled in the reactor up to a target preselected liquid level and the monomer mixture is polymerized so as to have a target solids content and then the volume (level) of the reaction mass is adjusted to a value at which the preselected liquid level in the reactor can be maintained. Thereafter, the reaction mass is extracted from the reactor and control is made and maintain the liquid level in the reaction region at a predetermined level.

The polymerization conditions are continuously maintained in the reactor so that a polymer having a selected conversion and a selected molecular weight can be obtained in the mixed solution or a selected solids content of the polymer can be obtained. The reaction region is operated so that a mixed solution having a polymer concentration, or solids content, of a minimum of about 50% by weight to a maximum of about 99% by weight, preferably about 70% by weight or more can be obtained. The charging liquid level of the reactor may be varied to a level corresponding to from a minimum of about 10% to about 100% at the most of the usable volume and can be controlled by any means, for example, a liquid level controlling meter and an interlocking control valve or a pump in a transfer line from the reactor.

Any means may be used for controlling the temperature in an inside of the reactor. It is preferable that the temperature of the reactor be controlled by circulating a coolant, for example, an oil in an internal cooling coil provided in the reactor. Most of the released polymerization heat can be removed by supplying the monomer composition, which is relatively colder and the internal cooling coil removes the residual heat to control the temperature of the mixed solution in the reactor to a preselected value, resulting in production of a polymer having the target conversion, average molecular weight, and molecular weight distribution.

When the concentration of the polymer is increased, the possibility of the damage by an accelerated reaction is substantially decreased. Generally, it is preferable that a polymer having an Mn of about 1,000 to about 3,000, a relatively narrow molecular weight distribution, and a solids content of about 80 to about 99% by weight be produced in the reaction region. In this case, the retention time in the reaction region is about 1 to about 30 minutes.

<Post-treatment Step>

Though the reaction product contains the crosslinkable vinyl polymer (C) in a high concentration, in order to further decrease unreacted monomers and the like in the reaction product, a step of removing unreacted monomers, reaction by-products, and/or the reaction solvent (S) can be taken after the bulk polymerization step.

Such unreacted monomers and/or solvent may be recovered and reused in the system.

The unreacted monomers are preferably circulated as monomers which are raw materials to be supplied. In the separation step, the volatile components, solvent and other by-products are eliminated and suitably solvents are circulated. Further, the volatile components can be easily removed from the reaction product by use of a conventional apparatus, for example, a thin film evaporator.

Generally, the apparatus used in the process of the present invention has been already known in the art and use of such apparatus is disclosed in U.S. Pat. No. 3,968,059 and U.S. Pat. No. 3,859,268, in which it is used for other bulk polymerization processes.

In the recovery step, the reaction product from which the low boiling point content has been removed is solidified by a suitable means or dissolved in a suitable solvent system. The solidified resin product may be processed into flakes by a conventional flaking apparatus. The flakes which are a product are packed by a known technology. For example, the flakes are suctioned into a bottle and then carried to a packaging machine.

The crosslinkable vinyl polymer (C) of the present invention can be easily compounded to find many applications such as enamel paints for electrical instruments, overprint varnishes, adhesives, exterior finisher for automobiles, trucks or aircraft, paints and the like.

Further, the crosslinkable vinyl polymer (C) of the present invention can be easily compounded for the application such as floor finishing materials, ink dispersants, water-based transparent overprint varnishes, impregnants, binders, plasticizers, leveling agents, melt flow improvers and the like.

Use of the crosslinkable vinyl polymer (C) of the present invention can provide paint systems that contains substantially no solvent and still are in an easy-to-use range of viscosity at room temperature. Such paint systems can be coated by the conventional industrial coating method such as hot spraying or roll coating.

The paints composed of the product produced by the process of the present invention can be used for cans, coils, woven fabrics, vinyl sheets, papers, metal furniture, wires, metal parts, wood panels and the like with the addition of auxiliary agents such as solvents, fillers, pigments, and flow adjusters.

Alkaline-soluble resins, that is, resins having an acidic functionality may be formulated into resin types in which an available aqueous base is used and are made to be contained in a floor polishing composition together with proper auxiliary additives such as acrylic, methacrylic or copolymer emulsions for plating, a wax emulsion, plasticizers, surfactants, organic solvents and/or an organic base antifoaming agent, thereby providing an excellent leveling property and detergent resistance. The wax formulations enable a colorless finishing coating having an excellent luster and have high resistances to yellowing and the action of detergents.

### EXAMPLES

The following examples are to explain certain preferred embodiments of the present invention and should not be considered to limit the present invention thereto.

In the following examples, the molecular weight of a-polymer product was measured by a gel permeation chromatography (GPC) using polystyrene as a standard substance.

The conversion was obtained by determining the amount of unreacted monomer by gas chromatography on a reaction product solution before the removal of the volatile components and unreacted monomers and calculated by the following equation.
Conversion (%)=[1−(amount of residual monomer)/(amount of charged monomer)]×100

The non-volatile content was determined as follows. That is, a suitable amount of the reaction product was taken in an aluminum cup and the weight is measured. Then, the reaction product was dried by evaporation of volatile components in an oven or a vacuum drier at 100° C. Again, the weight of the aluminum cup sample was measured. The content of the non-volatile components was obtained by the following equation.
Non-volatile content (%)=[1−((weight before drying)−(weight after drying))/(weight before drying)]×100

The yield was obtained by the following equation.
Yield(%)=100×(weight of product)/(weight of all the charged raw materials)

### Example 1

A 4-liter vertical tank reactor equipped with a temperature control jacket was maintained at a reaction temperature of 230° C. Up to 50% of the volume of the reactor, ethyl acrylate (EA) as the component (A) and an adduct (a number average molecular weight of 344; an OH value of 163; PCL FA2D manufactured by Daicel Chemical Industries, Ltd.) of 2 mol of ε-caprolactone to 2-hydroxyethyl acrylate produced by the method disclosed in JP 63-66307 B as the component (B) were charged in a weight ratio of 80/20 and di-tert-butyl peroxide was charged as the radical polymerization initiator (I) in a molar ratio of 0.0005 with respect to 1 mol of the total of the component (A) and the component (B).

As soon as the acrylic monomer mixture was introduced into the reactor, polymerization started. The content of the tank-type reactor was continuously stirred.

While separately supplying an additional acrylic monomer mixture and di-tert-butyl peroxide in fixed amounts at constant supply rates from raw material tanks, an outlet port was opened and the reaction mass was continuously extracted so that the 50% charged liquid level in the reactor was maintained. For this purpose, the supply rate was maintained at 0.12 kg/minute per 4 liters of the reactor volume in order to attain a retention time of 15 minutes. A heating medium was circulated in the jacket of the reactor to maintain a constant reaction temperature of 230° C.

Thereafter, the reaction mass was introduced into a thin film evaporator and volatile components including unreacted monomers and by-products were evaporated and the residue was recovered as a product. The yield was 96.3% of the theoretical yield.

As a result, an ethyl acrylate/2-hydroxyethyl acrylate-modified polycaprolactone copolymer having an Mn of 2,080, an Mw of 4,720, an Mz of 10,190, a molecular weight distribution of 2.27, and a distribution index of 4.97 was obtained as a product. The product had non-volatile components of 98.8% and a viscosity at 25° C. of 3,310 mPa.s as measured by an E-type viscometer. The results obtained are shown in Table 1 by test number F.

Further, data obtained in the same manner as described above except that the retention time was varied are shown in Table 1.

As shown in Table 1, all the samples produced had extremely uniform molecular weight distributions Mw/Mn and Mz/Mn, which were generally 2.3 or less and 5 or less, respectively. The various physical properties of the polymers were similar in any retention time, so that it is conceived that retention time gives substantially no influence on the physical properties.

TABLE 1

| Test | | | | | | | | |
|---|---|---|---|---|---|---|---|---|
| Number | A | B | C | D | E | F | G | H |
| Compo- | 80/20 | 80/20 | 80/20 | 80/20 | 80/20 | 80/20 | 80/20 | 80/20 |
| nent | | | | | | | | |
| A/B | | | | | | | | |
| (weight | | | | | | | | |
| ratio) | | | | | | | | |
| Reten- | 1 | 2 | 3 | 5 | 10 | 15 | 20 | 30 |
| tion | | | | | | | | |
| time | | | | | | | | |
| (min- | | | | | | | | |
| ute) | | | | | | | | |
| Visco- | 2610 | 3320 | 3510 | 3600 | 3620 | 3310 | 3820 | 4560 |
| sity | | | | | | | | |
| (mpa.s) | | | | | | | | |
| 25° C. | | | | | | | | |
| Mn | 2050 | 2110 | 2150 | 2060 | 2040 | 2080 | 2020 | 2140 |
| Mw | 4310 | 4950 | 4600 | 4490 | 4530 | 4720 | 4550 | 4920 |
| Mz | 9120 | 9710 | 9910 | 9640 | 9830 | 10190 | 10000 | 10550 |
| Mw/Mn | 2.10 | 2.13 | 2.14 | 2.18 | 2.22 | 2.27 | 2.25 | 2.30 |
| Mz/Mn | 4.45 | 4.60 | 4.61 | 4.68 | 4.82 | 4.90 | 4.95 | 4.93 |
| OH | 81.5 | 81.3 | 82.0 | 81.3 | 81.6 | 81.1 | 80.3 | 79.9 |
| number | | | | | | | | |
| (mg | | | | | | | | |
| KOH | | | | | | | | |
| /g) | | | | | | | | |
| Tg | +54 | +54 | +53 | +54 | +53 | +52 | +51 | +50 |
| (° C.) | | | | | | | | |
| Conver- | 97.3 | 97.8 | 96.4 | 83.3 | 85.8 | 97.6 | 95.1 | 96.2 |
| sion | | | | | | | | |
| (%) | | | | | | | | |

In the following examples and comparative examples, di-tert-butyl peroxide of 0.0005 mol % was used as the initiator per 1 mol of the total of the component (A) and the component (B), and the retention time was 15 minutes unless otherwise noted specifically.

### Example 2

The same procedures as those in Example 1 were repeated except that the retention time was constant and the weight ratio of ethyl acrylate (EA) to2-hydroxyethyl acrylate-modified polycaprolactone (PCL-FA2D) was varied between 100/0 to 30/70.

The obtained polymer was cured with an alkylated melamine-formaldehyde resin (Cymel 301, manufactured by American Cyanamid) and evaluation was made as a coating layer. 2 parts of a curing agent was added to 10 parts of the acrylic resin, and after stirring, the mixture was uniformly coated on a steel plate of 1 mm in thickness×70 mm in width×150 mm in length with a #20 bar coater and then cured in an oven at 120° C. for 30 minutes. The cured coating layer was subjected to a pencil hardness test based on the test method of JIS S-6006, an adhesion test to a steel plate by a cross-cut adhesion test and an impact strength test by dropping a steel ball. The results-obtained are shown in Table 2.

The polymers containing no 2-hydroxyethyl acrylate-modified polycaprolactone provided a coating layer that is brittle and has a poor adhesion. Further, the polymers having a 2-hydroxyethyl acrylate-modified polycaprolactone content of 70% by weight or more do not exhibit a satisfactory hardness.

TABLE 2

| Test Number | I | J | K | L | M | N |
|---|---|---|---|---|---|---|
| Component A/B | 100/0 | 80/20 | 70/30 | 60/40 | 40/60 | 30/70 |
| (weight ratio) | | | | | | |
| Retention time | 15 | 15 | 15 | 15 | 15 | 15 |
| (minute) | | | | | | |
| Viscosity | 1930 | 3310 | 3560 | 3510 | 3920 | 4450 |
| (mPa · s) 25° C. | | | | | | |
| Mn | 1370 | 2080 | 2470 | 2670 | 3260 | 3450 |
| Mw | 2600 | 4720 | 5580 | 5820 | 6940 | 7450 |
| Mz | 5210 | 10190 | 12130 | 11800 | 15160 | 16110 |
| Mw/Mn | 1.9 | 2.27 | 2.26 | 2.18 | 2.13 | 2.16 |
| Mz/Mn | 3.8 | 4.90 | 4.91 | 4.42 | 4.65 | 4.67 |
| OH number | — | 81.1 | 103.0 | 121.2 | 143.4 | 147.3 |
| (mgKOH/g) | | | | | | |
| Tg (° C.) | +45 | +52 | 22 | −5 | −24 | −42 |
| Conversion (%) | 96.2 | 97.6 | 97.4 | 97.2 | 96.4 | 96.1 |
| Pencil hardness | H | 2H | 2H | 2H | H | B |
| Cross-cut | 6 | 10 | 10 | 10 | 10 | 10 |
| adhesion test | | | | | | |
| Steel ball drop | Cracks | No | No | No | No | No |
| test | | crack | crack | crack | crack | crack |

### Comparative Example 1

Polymers were synthesized and coating layers made therefrom were evaluated in the same procedures as those in Example 2 except that the 2-hydroxyethyl acrylate-modified polycaprolactone was replaced by 2-ethylhexyl acrylate (abbreviated as EtHxA in Table 3) and the weight ratio of ethyl acrylate (EA) to2-ethylhexylacrylate was varied between 20/80 to 50/50 as shown in Table 3.

The results obtained indicate that replacement of the 2-ethylhexyl acrylate-modified caprolactone by 2-ethylhexyl acrylate makes the coating film brittle and deteriorates the impact strength thereof. The results thereof are shown in Table 3.

TABLE 3

| Test Number | O | P | Q | R |
|---|---|---|---|---|
| Component A/EtHxA | 20/80 | 30/70 | 40/60 | 50/50 |
| (weight ratio) | | | | |
| Retention time (minute) | 15 | 15 | 15 | 15 |
| Viscosity (mPa · s) 25° C. | 3010 | 3320 | 3490 | 3980 |
| Mn | 1390 | 1430 | 1480 | 1530 |
| Mw | 3100 | 3200 | 3270 | 3600 |
| Mz | 6570 | 6600 | 6530 | 6990 |
| Mw/Mn | 2.23 | 2.24 | 2.21 | 2.35 |
| Mz/Mn | 4.73 | 4.61 | 4.41 | 4.57 |
| Tg (° C.) | +42 | +22 | +7 | −14 |
| Conversion (%) | 96.6 | 98.4 | 96.2 | 96.4 |
| Pencil hardness | 2H | 2H | 2H | H |
| Cross-cut adhesion test | 8 | 10 | 10 | 10 |
| Steel ball drop test | Cracks | Cracks | Cracks | Cracks |

### Comparative Example 2

### Reaction in a Batch-type Reactor

In a four-necked flask equipped with an air supply tube, a thermometer, a condenser tube and a stirrer, were added ethyl acrylate (EA) and an adduct of 2-hydroxyethyl acrylate with about 2 mol of ε-caprolactone (PCL-FA2D, abbreviated as FA2D in Table 4) in a weight ratio of 80:20 to 70% of the volume of the flask and methyl ethyl ketone as a solvent in such an amount that the weight of the monomer mixture became 70% by weight based on the total composition. Further, di-tert-butyl peroxide was charged thereinto in a molar ratio of 0.5:1 with respect to the monomer mixture. The resultant reaction mixture was stirred while introducing air therein and heating was started. The temperature was maintained at 80° C. and polymerization was continued for about 15 hours. Thereafter, hydroquinone monomethyl ether (HQME) as a polymerization inhibitor was added to the reaction mixture in an amount of 0.05% by weight based on the weight of the reaction mixture. Then, the reaction mixture was cooled to 50° C. and the solvent was removed by evaporation under reduced pressure to recover a polymer product. The product was obtained in a yield of 95.3% of the theoretical yield.

Thus, an ethyl acrylate/2-hydroxyethyl acrylate-caprolactone copolymer having an Mn of 2,030, an Mw of 6,790, an Mz of 18,130, a molecular weight distribution of 3.34, and a distribution index of 8.93 was obtained. The produced polymer had a non-volatile content of 97.8% and a viscosity at 25° C. as measured by an E-type viscometer of 6,430 mPa.s. Further, data obtained by similar methods except that the amounts of PCL-FA2D and ethyl acrylate were changed are shown in Table 4.

As shown in Table 4, when polymers were produced in a batch process as has been conventionally used, a solvent had to be used in order to prevent reaction overrun. Therefore, the obtained copolymer had a broad molecular weight distribution. Also, it had a high viscosity in spite of use of a solvent, so that the coatability was poor. In addition, in the coating layers prepared from polymers having low contents of PCL-FA2D, cracks occurred.

TABLE 4

| Test Number | S | T | U |
|---|---|---|---|
| EA/FA2D (weight ratio) | 80/20 | 70/30 | 60/40 |
| Reaction time (minute) | 15 | 15 | 15 |
| Viscosity (mPa · s) 25° C. | 6430 | 5950 | 7410 |
| Mn | 2030 | 1910 | 2050 |
| Mw | 6790 | 5950 | 6600 |
| Mz | 18130 | 16710 | 18910 |
| Mw/Mn | 3.34 | 3.12 | 3.22 |
| Mz/Mn | 8.93 | 8.75 | 9.22 |
| OH number (mgKOH/g) | 32.6 | 48.9 | 65.2 |
| Tg (° C.) | +24 | +10 | −3 |
| Conversion (%) | 95.3 | 95.8 | 96.4 |
| Pencil hardness | 2H | H | B |
| Cross-cut adhesion test | 8 | 9 | 10 |
| Steel ball drop test | Cracks | Cracks | No crack |

The continuous bulk polymerization process of the present invention can provide acrylic polymers that have uniform molecular weights and narrow molecular weight distributions and that are solvent free or have high solids contents. Further, special unsaturated aliphatic hydroxyalkyl ester-modified polycaprolactone contained as a copolymer component can provide resins that are friendly to the environment, have excellent workability and are suitable for use in, for example, paints, coating materials, adhesives and pressure-sensitive adhesives.

1. A continuous bulk polymerization process for production of a crosslinkable vinyl polymer (C), comprising reacting a vinyl monomer (A), an unsaturated fatty acid hydroxyalkyl ester-modified polycaprolactone (B) represented by general formula (1) 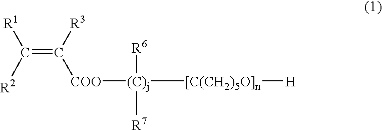
(wherein R¹, R² and R³, which are the same or different from each other, independently represent a hydrogen atom or an alkyl group having 1 to 7 carbon atoms, or an alkoxy group having 1 to 7 carbon atoms, and R⁶ and R⁷ independently represent a hydrogen atom or an alkyl group having 1 to 10 carbon atoms; j is an integer of 2 to 7, provided that (R⁶)s and (R⁷)s attached to j pieces of carbon atoms are the same or different from each other; and n is an integer of 1 to 10), and a radical polymerization initiator (I) in a continuously mixing reactor to produce the crosslinkable vinyl polymer having a number average molecular weight of about 500 to about 10,000.

2. A continuous bulk polymerization process according to claim 1, wherein the vinyl monomer (A) is an acrylic monomer.

3. A continuous bulk polymerization process according to claim 1, wherein the unsaturated fatty acid hydroxyalkyl ester-modified polycaprolactone (B) is an adduct of about 1 mol of an unsaturated fatty acid hydroxyalkyl ester with about 1 to about 10 mol of ε-caprolactone.

4. A continuous bulk polymerization process according to claim 3, wherein the unsaturated fatty acid hydroxyalkyl ester is hydroxyethyl (meth)acrylate.

5. A continuous bulk polymerization process according to claim 1, wherein the crosslinkable vinyl polymer (C) comprises about 0.1 to about 70% by weight of a unit derived from the unsaturated fatty acid hydroxyalkyl ester-modified polycaprolactone (B) based on 100% by weight of total units derived from the vinyl monomer (A) and the unsaturated fatty acid hydroxyalkyl ester-modified polycaprolactone (B).

6. A continuous bulk polymerization process according to claim 1, wherein the radical polymerization initiator (I) is at least one member selected from the group consisting of a peroxide and a hydroperoxide.

7. A continuous bulk polymerization process according to claim 1, wherein the radical polymerization initiator (I) is added in a ratio of about 0.0005 to about 0.06 mol per 1 mol of total of the vinyl monomer (A) and the unsaturated fatty acid hydroxyalkyl ester-modified polycaprolactone (B).

8. A continuous bulk polymerization process according to claim 1, wherein a yield of the polymerization reaction is about 90% by weight or more.

9. A continuous bulk polymerization process according to claim 1, wherein the polymerization reaction is carried out by the addition of a solvent (S) for a reaction in a ratio of about 25% or less by weight with respect to the total weight of the vinyl monomer (A) and the unsaturated fatty acid hydroxyalkyl ester-modified polycaprolactone (B).

10. A continuous bulk polymerization process according to claim 9, wherein the solvent (S) for a reaction is at least one member selected from the group consisting of aromatic or aralkyl alcohols; aliphatic glycols; (poly)alkylene glycol dialkyl ethers;
aliphatic or aromatic ethers; alicyclic or aromatic esters; and alicyclic or aromatic hydrocarbons with a boiling point of about 100 to about 270° C.

11. A continuous bulk polymerization process according to claim 1, further comprising a process through which at least one of unreacted monomers, by-products, and the solvent (S) for a reaction are removed after the polymerization reaction is completed.

12. A continuous bulk polymerization process according to claim 1, wherein the reaction is carried out at temperatures of about 180 to about 270° C. and at retention times of about 1 to about 50 minutes.

13-14. (canceled)
